(19) United States
(12) Patent Application Publication
(10) Pub. No.: US 2025/0360527 A1
(43) Pub. Date: Nov. 27, 2025

(54) IRRIGATION SYSTEM WHICH TRANSMITS A NOTIFICATION THAT A FAULT HAS CLEARED

(71) Applicant: Lindsay Corporation, Omaha, NE (US)

(72) Inventors: Reece Robert Andrews, Omaha, NE (US); Mark William Miller, Omaha, NE (US)

(21) Appl. No.: 18/669,645

(22) Filed: May 21, 2024

(51) Int. Cl. B05B 12/08; A01G 25/09; A01G 25/16; B05B 3/12

(52) U.S. Cl. CPC B05B 12/08; A01G 25/092; A01G 25/16; B05B 3/12

(57) ABSTRACT

An irrigation system comprises a plurality of towers, a safety switch status determination unit, and a controller. At least a portion of the towers includes a successive one of a plurality of safety switches, each safety switch being either closed or open. The safety switch status determination unit is configured to determine a status of the safety switches, and output an electronic safety switch status signal whose level or data value varies according to whether all of the safety switches are closed or one of the safety switches is open. The controller is configured to instruct the safety switch status determination unit to determine the status of the safety switches, receive the safety switch status signal, and perform at least one of a plurality of steps if the safety switch status signal indicates that all of the safety switches are closed.

### FIELD OF THE INVENTION

Embodiments of the current invention relate to mechanized irrigation systems configured to detect that a fault has occurred and determine if the fault corrects itself.

### BACKGROUND OF THE INVENTION

Mechanized irrigation systems comprise a plurality of spaced-apart, motorized, and self-propelled towers which support a fluid-carrying conduit and sprayer system that sprays the fluid on one or more crops. In a center-pivot irrigation system, the conduit is coupled to a fluid source at a center pivot point, and the towers travel in a roughly circular path around the center pivot. Between each adjacent pair of towers is a successive one of a plurality of sections of the conduit, wherein each adjacent pair of conduit sections is coupled with a successive one of a plurality of joints that is flexible. The towers travel independently of one another and may travel at different speeds and at different times. Thus, during normal operation, the towers may travel such that there is a non-zero alignment angle between adjacent sections of the conduit. Some variation of the alignment angle, both positive and negative, is acceptable. However, for numerous reasons the alignment angle may exceed a safe threshold. To monitor the alignment angle, each tower includes a safety switch coupled to the conduit on each adjacent section. The safety switch is normally closed, but will open if the alignment angle between two towers and the associated sections of conduit exceeds the safe threshold. A central controller, which controls the operation of the irrigation system, senses the open safety switch and turns off electric power to shut down the operation of the irrigation system and drains the fluid from the conduit. In certain situations, after the electric power is turned off, the safety switch that was open may close again. For example, in one scenario, the tower that was out of alignment may have wandered onto a ridge or slope on which the crops grow. With power to the tower's electric motor removed, the tower may roll down the slope and back into safe alignment, which in turn, closes the safety switch. In another scenario, the fluid in the conduit may have been causing stress on the structure of the irrigation system which caused the safety switch to open. With the fluid being drained, the structure may relax and the open safety switch may close. Most likely, in both scenarios, the irrigation system can operate again safely. The problem with traditional irrigation systems is that once the central controller shuts down operation, there is no way to recheck for the safety switch being closed again.

The background discussion is intended to provide information related to the present invention which is not necessarily prior art.

### SUMMARY OF THE INVENTION

Embodiments of the current invention address one or more of the above-mentioned problems and provide irrigation systems that not only are able to check a status of the safety switches after a shut down has occurred, but are also able to notify a user if a fault that caused the shut down has cleared. One embodiment of the irrigation system broadly comprises a plurality of towers, a safety switch status determination unit, and a central controller. At least a portion of the towers includes a successive one of a plurality of safety switches, each safety switch being either closed or open. The safety switch of each tower is electrically connected to at least one safety switch of another tower. The safety switch status determination unit is configured to determine a status of the safety switches, and output an electronic safety switch status signal whose level or data value varies according to whether all of the safety switches are closed or one of the safety switches is open. The central controller is configured to receive an indication of an irrigation system fault, cease operation of the irrigation system, optionally wait for a period of time, instruct the safety switch status determination unit to determine the status of the safety switches, receive the safety switch status signal, perform at least one of the following steps if the safety switch status signal indicates that all of the safety switches are closed: transmit externally, and/or display locally, a message indicating that the irrigation system had a shutdown, but is no longer in an unsafe condition and can now be restarted, restart operation of the irrigation system, and transmit externally, and/or display locally, a message indicating that the irrigation system had a shutdown and has been restarted.

Another embodiment of the current invention provides an irrigation system broadly comprising a plurality of towers, a safety switch status determination unit, and a central controller. At least a portion of the towers includes a successive one of a plurality of safety switches, each safety switch being either closed or open. The safety switch of each tower is electrically connected to at least one safety switch of another tower. The safety switch status determination unit is electrically connected to a safety switch circuit including the switches, a switch cable having a plurality of sections that electrically connect the safety switches to one another, and a return cable electrically connected the safety switch at a last tower. The safety switch status determination unit is configured to determine a status of the safety switches, and output an electronic safety switch status signal whose level or data value varies according to whether all of the safety switches are closed or one of the safety switches is open. The central controller is configured to receive an indication of an irrigation system fault, cease operation of the irrigation system, optionally wait for a period of time, instruct the safety switch status determination unit to determine the status of the safety switches, receive the safety switch status signal, and perform at least one of the following steps if the safety switch status signal indicates that all of the safety switches are closed: transmit externally, and/or display locally, a message indicating that the irrigation system had a shutdown, but is no longer in an unsafe condition and can now be restarted, restart operation of the irrigation system, and transmit externally, and/or display locally, a message indicating that the irrigation system had a shutdown and has been restarted. The central controller is further configured to perform the following steps if the safety switch status signal indicates that one of the safety switches is open: determine an identification of, a position of, or a distance to, the open safety switch, and transmit externally, and/or display locally, a message indicating the identification of, the position of, or the distance to, the tower that has the open safety switch.

Yet another embodiment of the current invention provides a method for notifying a user that an irrigation system fault has been cleared, the irrigation system including a plurality of towers, with at least a portion of the towers including a successive one of a plurality of safety switches, each safety switch being either closed or open. The method comprises: receiving an indication of an irrigation system fault; ceasing operation of the irrigation system; optionally waiting for a first period of time; determining if a safety switch is open or if all safety switches are closed; performing at least one of the following steps if all safety switches are closed; transmitting externally, and/or displaying locally, a message indicating that the irrigation system had a shutdown, but is no longer in an unsafe condition and can now be restarted; restarting operation of the irrigation system; and transmitting externally, and/or display locally, a message indicating that the irrigation system had a shutdown and has been restarted.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a perspective environmental view of an irrigation system, constructed in accordance with various embodiments of the current invention, including a plurality of towers and a plurality of safety switches, each safety switch associated with a successive one of the towers, the irrigation system configured to notify a user that an irrigation system fault has been cleared;

FIG. 2 is a schematic block diagram of an electrical connection of the safety switches, a central controller, and a first embodiment of a safety switch status determination unit;

FIG. 3 is a schematic block diagram of an electrical connection of the safety switches, the central controller, and a second embodiment of a safety switch status determination unit;

FIG. 4 is a schematic block diagram of the electrical components of a first embodiment of the safety switch status determination unit;

FIG. 5 is a schematic block diagram of the electrical components of a second embodiment of the safety switch status determination unit;

FIG. 6 is a schematic block diagram of the electrical components of a third embodiment of the safety switch status determination unit;

FIG. 7 is a schematic block diagram of the electrical components of a fourth embodiment of the safety switch status determination unit; and

FIGS. 8A and 8B include a listing of at least a portion of the steps of a method of notifying a user that an irrigation system fault has been cleared.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

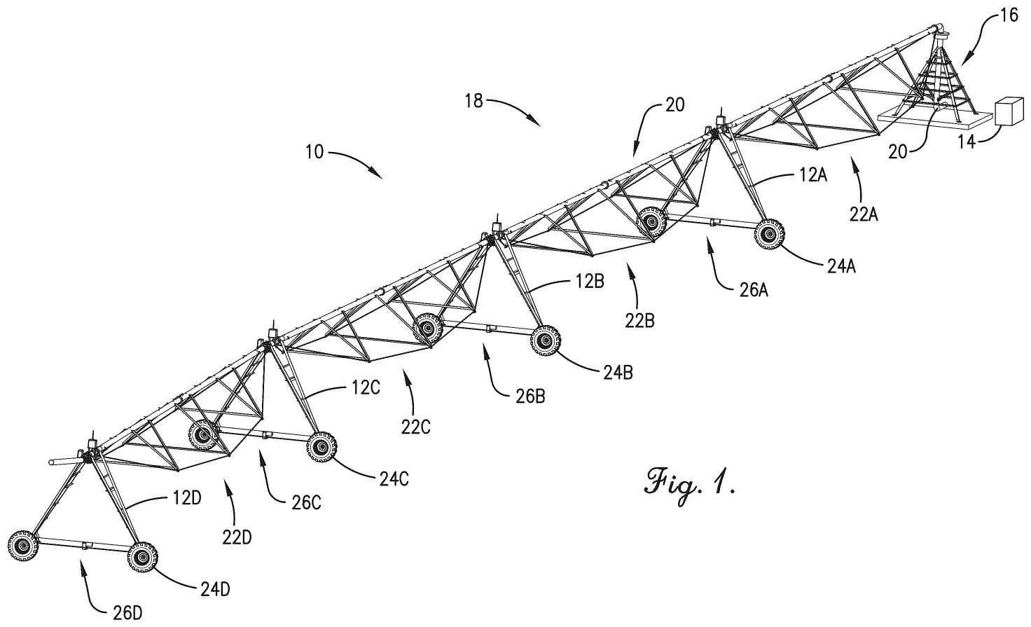

A mechanized irrigation system 10, constructed in accordance with various embodiments of the current invention, is shown in FIG. 1. The irrigation system 10 broadly comprises a plurality of towers 12 which support fluid delivery components along with a central controller 14 that controls operation of the irrigation system 10. An exemplary embodiment of the irrigation system 10, shown in FIG. 1, is a center pivot irrigation system and broadly comprises a fixed center pivot 16 and a main section 18 pivotally connected to the center pivot. The irrigation system 10 may also comprise an extension arm (also commonly referred to as a “swing arm” or “corner arm”) pivotally connected to the free end of the main section 18. The irrigation system 10 may also be embodied by a lateral, or linear, move apparatus which irrigates while moving in a linear, or near-linear, direction without departing from the scope of the current invention.

The fixed center pivot 16 may be a tower or any other support structure about which the main section 18 may pivot. The center pivot has access to a well, water tank, or other source of water or other fluid and may also be coupled with a tank or other source of agricultural products to inject fertilizers, pesticides and/or other chemicals into the water for application during irrigation. The center pivot 16 may supply fluid to a conduit 20 which carries the fluid along the length of the main section 18.

The main section 18 may comprise any number of mobile support towers 12A-D, the outermost tower 12D of which is referred to herein as an end tower. The towers 12A-D are connected to the fixed center pivot 16 and to one another by truss sections 22A-D or other supports to form a number of interconnected spans.

The towers 12 have wheels 24A-D, at least one of which is driven by suitable drive motors 26A-D. Each motor 26A-D turns at least one of its wheels 24A-D through a drive shaft to propel its tower 12 and thus the main section 18 in a circle about the center pivot 16 to irrigate a field. The motors 26 may also have several speeds or be equipped with variable speed drives. The operation of the motors 26A-D, such as whether they are on or off, the speed of travel, and the direction of travel, may be controlled with one or more electronic signals or digital data.

Each of the truss sections 22A-D carries or otherwise supports the conduit 20 and other fluid distribution mechanisms that are connected in fluid communication to the conduit 20. Fluid distribution mechanisms may include sprayers or diffusers, each optionally attached to a drop hose, or the like. Between each adjacent pair of towers 12A-D is a successive one of a plurality of sections of the conduit 20, wherein each adjacent pair of conduit 20 sections is coupled with a successive one of a plurality of joints that is flexible. In addition, the conduit 20 may include one or more valves which control the flow of fluid through the conduit 20. The opening and closing of the valves may be automatically controlled with an electronic signal or digital data.

The irrigation system 10 may also include wired or wireless communication electronic components that communicate with a communication network and allow the valves and the motors 26 to receive the electronic signals and/or digital data which control the operation of the valves and the motors 26.

The irrigation system 10 may also include an optional extension arm (not shown) pivotally connected to the end tower 12D and may be supported by a swing tower 12 with steerable wheels 24 driven by a motor 26. The extension arm may be joined to the end tower 12D by an articulating pivot joint. The extension arm is folded in relative to the end tower 12D when it is not irrigating a corner of a field and may be pivoted outwardly away from the end tower 12D while irrigating the corners of a field.

The irrigation system 10 may further include one or more sensors which measure the amount of fluid delivered from the irrigation system 10 to the crop. The sensors may communicate with the communication network to report the amount of delivered fluid. The fluid may be reported as a depth in units of millimeters (mm) or inches (in).

The irrigation system 10 illustrated in FIG. 1 has four towers 12A-D; however, it may comprise a larger number of towers, truss sections, wheels, and drive motors without departing from the scope of the current invention.

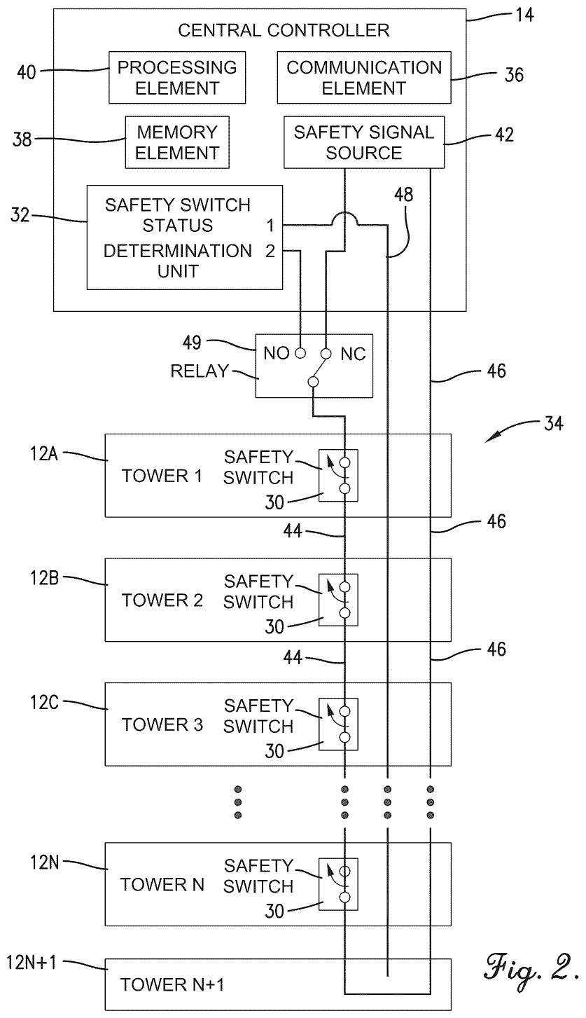

In addition, the irrigation system 10 includes a plurality of safety switches 30, with each safety switch 30 being positioned at, and associated with, a successive one of the towers 12 and coupled to the two adjacent sections of the conduit 20 that are joined at the tower 12, although the last tower 12D (in FIG. 1), 12N+1 (in FIG. 2) typically does not have a safety switch 30. Each safety switch 30 monitors an alignment angle between one section of the conduit 20 and its adjacent inward section of the conduit 20. The safety switch 30 opens when its associated tower 12 moves its section of the conduit 20 into an unsafe alignment or position, which, in turn, leads to the central controller 14 switching off electric power to shut down operation of the irrigation system 10. The central controller 14 may also open the appropriate valves along the conduit 20 to allow the fluid to drain from the irrigation system 10.

There may be numerous causes for one of the towers 12 to move its section of the conduit 20 into an unsafe alignment or position so that the safety switch 30 is opened. For example, in one scenario, the tower 12 may have wandered onto a ridge or slope on which the crops grow or may have been caught in a groove or rut. When electric power is cut from the motor 26 driving the tower 12, the tower 12 may roll or move back into a position that brings its section of the conduit 20 back into safe alignment which closes the safety switch 30. In another scenario, the fluid in the conduit 20 may have been causing stress on the structure of the irrigation system 10, such as the truss sections 22 between the towers 12, which caused the safety switch 30 to open. With the fluid being drained, the structure may relax and the open safety switch 30 may close. Most likely, in both scenarios, the irrigation system 10 can operate again safely.

Embodiments of the irrigation system 10 further comprise a safety switch status determination unit 32, which determines an open and closed status of the safety switches 30. That is, when one of the safety switches 30 opens, the safety switch status determination unit 32 outputs a signal or data which varies according to the open safety switch 30. And, when the safety switches 30 are all closed, the safety switch status determination unit 32 outputs a signal or data which indicates that all safety switches 30 are closed even when the irrigation system 10 is shut down.

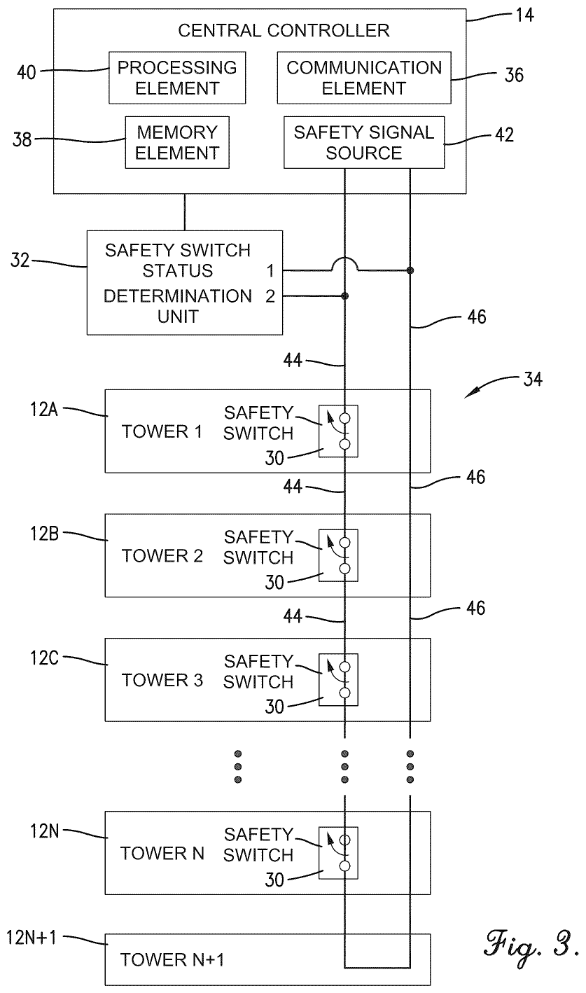

Referring to FIGS. 2 and 3, the central controller 14 is electrically connected to a safety switch circuit 34. In addition, the central controller 14 comprises a communication element 36, a memory element 38, a processor 40, and a safety signal source 42, each of which is typically integrated with the central controller 14, perhaps in the same housing, or the components may be physically located elsewhere or geographically distributed. Furthermore, the safety switch status determination unit 32 may be integrated with, or housed with, the central controller 14, as shown in FIG. 2. Or as shown in FIG. 3, the safety switch status determination unit 32 may be located external to the central controller 14, but in electronic communication with the central controller 14.

In some embodiments, the safety switch status determination unit 32 includes data processing components on site (proximal to the irrigation system 10) that perform operations and/or computations sufficient to determine an open and closed status of the safety switches 30. In other embodiments, the safety switch status determination unit 32 includes one or more data processing components off site (external to the irrigation system 10) that perform operations and/or computations sufficient to determine an open and closed status of the safety switches 30. For example, the safety switch status determination unit 32 may transmit data to cloud computing services which determine an open and closed status of the safety switches 30 and transmit the status data back to the safety switch status determination unit 32.

The communication element 36 generally allows the central controller 14 to communicate with external systems, computing networks, telecommunication networks, the Internet, and the like. The communication element 36 may include signal and/or data transmitting and receiving circuits, such as antennas, amplifiers, filters, mixers, oscillators, digital signal processors (DSPs), and the like. The communication element 36 may establish communication wirelessly by utilizing radio frequency (RF) signals and/or data that comply with communication standards such as cellular 2G, 3G, 4G, Voice over Internet Protocol (VOIP), LTE, Voice over LTE (VOLTE), or 5G, Institute of Electrical and Electronics Engineers (IEEE) 802.11 standard such as WiFi, IEEE 802.16 standard such as WiMAX, Bluetooth™, or combinations thereof. In addition, the communication element 36 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 36 may establish communication through connectors or couplers that receive metal conductor wires or cables which are compatible with networking technologies such as ethernet. In certain embodiments, the communication element 36 may also couple with optical fiber cables. The communication element 36 may be in electronic communication with the memory element 38 and the processor 40.

The memory element 38 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 38 may be embedded in, or packaged in the same package as, the processor 40. The memory element 38 may include, constitute, or embody, a non-transitory “computer-readable medium”. The memory element 38 may store the instructions, code, code statements, code segments, software, firmware, programs, applications, apps, services, daemons, or the like that are executed by the processor 40. The memory element 38 is in electronic communication with the processor 40 and may also store data that is received by the processor 40 or the device in which the processor 40 is implemented. The processor 40 may further store data or intermediate results generated during processing, calculations, and/or computations as well as data or final results after processing, calculations, and/or computations. In addition, the memory element 38 may store settings, text data, documents from word processing software, spreadsheet software and other software applications, sampled audio sound files, photograph or other image data, movie data, databases, and the like.

The processor 40 may comprise one or more processors that include electronic hardware components such as microprocessors (single-core or multi-core), microcontrollers, digital signal processors (DSPs), field-programmable gate arrays (FPGAs), analog and/or digital application-specific integrated circuits (ASICs), intelligence circuitry, or the like, or combinations thereof. The processor 40 may generally execute, process, or run instructions, code, code segments, code statements, software, firmware, programs, applications, apps, processes, services, daemons, or the like. The processor 40 may also include hardware components such as registers, finite-state machines, sequential and combinational logic, configurable logic blocks, and other electronic circuits that can perform the functions necessary for the operation of the current invention. In certain embodiments, the processor 40 may include multiple computational components and functional blocks that are packaged separately but function as a single unit. In some embodiments, the processor 40 may further include multiprocessor architectures, parallel processor architectures, processor clusters, and the like, which provide high performance computing. The processor 40 may be in electronic communication with the other electronic components of the central controller 14 through serial or parallel links that include universal busses, address busses, data busses, control lines, and the like. In addition, the processor 40 may include ADCs to convert analog electronic signals to (streams of) digital data values and/or digital to analog converters (DACs) to convert (streams of) digital data values to analog electronic signals.

The processor 40 is operable, configured, and/or programmed to perform the functions, operations, processes, methods, and/or algorithms of the central controller 14, as discussed in more detail below, by utilizing hardware, software, firmware, or combinations thereof. Other components, such as the communication element 36 and the memory element 38 may be utilized as well. The central controller 14 may also have access to, and be in electronic communication with, cloud computing services, wherein a portion of the functions, operations, processes, methods, and/or algorithms of the central controller 14 are performed by computing resources off-site. Additionally, or alternatively, the processor 40 may include components, such as cloud computing components, that are physically located in a plurality of different geolocations. The components are able to communicate with each other to provide cohesive operation.

The safety signal source 42 generally checks for electrical continuity (i.e., a closed electrical circuit) on the safety switch circuit 34, wherein a lack of electrical continuity likely indicates that at least one of the safety switches 30 is open. The safety signal source 42 includes a first port and a second port to which electrical connections to the safety switch circuit 34 are made and across which electrical continuity is determined. The safety signal source 42 also outputs an electronic safety signal, which is received by the processor 40, whose electrical characteristic level (voltage or current) or data varies according to the electrical continuity status. For example, the safety signal may have a first level or data value that indicates electrical continuity is present (for all safety switches 30 closed) and a second level or data value that indicates electrical continuity is absent (for at least one safety switch 30 being open).

Referring to FIG. 2, in some embodiments, the safety switch circuit 34 is formed by the safety switches 30, a switch cable 44, a return cable 46, and an impedance cable 48. Each safety switch 30 is embodied by a single-pole, single-throw (SPST) type switch, or any type of switch that includes a first terminal and a second terminal with a moveable contact providing electrical connection between the terminals in a closed position and no electrical connection in an open position. The safety switch 30 is closed when the alignment angle between the two sections of the conduit 20 joined at the associated tower 12 is below or equal to a safety threshold value and open when alignment angle is above the safety threshold value. The safety switch 30 may be implemented as a limit switch that is integrated in a mechanical assembly which includes a rotating cam mechanically coupled to the conduit 20 at the joint where two sections of the conduit 20 are connected. The cam rotates in response to the rotation of the outward section of the conduit 20 with respect to the inward section of the conduit 20, and thus the angular position of the cam represents the alignment angle between the two sections of the conduit 20. An exemplary embodiment of the safety switch 30 assembly is described in U.S. Pat. No. 9,538,712, which is hereby incorporated by reference, in its entirety, into the current patent application, except where inconsistent with the teachings of the current patent application. Rotation of the cam beyond the safety threshold angle, in either the clockwise direction or the counter clockwise direction, opens the safety switch 30.

Each of the safety switches 30 is electrically connected to the safety signal source 42 through the switch cable 44 and the return cable 46, as shown in FIG. 2. The switch cable 44 includes a plurality of sections, wherein a first section electrically connects the first port of the safety signal source 42 to the safety switch 30 at the first tower 12A. A successive one of other sections of the switch cable 44 electrically connects each successive adjacent pair of safety switches 30 to one another so that all of the safety switches 30 are electrically connected in series. The return cable 46 electrically connects the safety switch 30 at the next to the last tower 12N to the second port of the safety signal source 42, although the switch cable 44 and the return cable 46 may each extend to the last tower 12N+1. The safety switches 30, the switch cable 44, and the return cable 46 form an electrically conductive closed circuit path when all of the safety switches 30 are closed, which may be known as a “normal state”. Having all of the safety switches 30 closed also allows for the safety signal to be sent and received by the safety signal source 42.

The impedance cable 48 is an electrically conductive cable that is electrically connected to the safety switch status determination unit 32 and extends from the central controller 14 (typically located at the center pivot 16) to the last tower 12N+1 and positioned in general proximity to the switch cable 44. The impedance cable 48 may be utilized for other control purposes when the irrigation machine is running, such as FWD, REV, % SPEED, End Gun1 and End Gun2 commands.

The irrigation system 10 further includes a relay 49 that is utilized to electrically isolate the safety switch status determination unit 32 from the safety signal source 42. The relay 49 includes a common contact that is electrically connected to the switch cable 44 between the central controller 14 and the safety switch 30 of the first tower 12A. The relay 49 further includes a normally closed (NC) contact that is electrically connected to one port of the safety signal source 42, and a normally open (NO) contact that is electrically connected to the safety switch status determination unit 32. In the non-energized state of the relay 49, the switch cable 44 is electrically connected to the safety signal source 42. In the energized state of the relay 49, the switch cable 44 is electrically connected to the safety switch status determination unit 32. The state of the relay 49, i.e., non-energized or energized, is determined by the processor 40 through one or more control lines.

Referring to FIG. 3, in other embodiments, the safety switch circuit 34 is formed by the safety switches 30, the switch cable 44, and the return cable 46, but not the impedance cable 48 and the relay 49.

The processor 40 generally controls the operation of the irrigation system 10 by receiving data from sensors and other components and by outputting control signals to the valves and drive motors 26. The data from the sensors may include data about the amount of fluid that is being delivered to the crops. As a result, the processor 40 may output signals to the valves to control the flow of fluid and to the drive motors 26 to control the speed of travel of the towers 12 according to the values of the data.

The processor 40 also receives the safety signal from the safety signal source 42. If the safety signal indicates that the there is electrical continuity on the safety switch circuit 34, then the processor 40 takes no specific action. If the safety signal indicates that a lack of electrical continuity on the safety switch circuit 34, then the processor 40 may wait for a brief time, such as a few seconds or less, in case one of the safety switches 30 momentarily opened and then closed again. After the brief time passes, the processor 40 may halt operation of the irrigation system 10 by opening a switch, a relay, or a contactor that supplies electric power to the motors 26 and to the fluid delivery system. The processor 40 also controls the settings of the pumps, valves, and other components of the fluid delivery system to drain the fluid from the fluid delivery system including the conduit 20. Draining of the fluid delivery system may take approximately 15-20 minutes.

The processor 40 outputs an electronic control signal, including a voltage or current level or data, to the safety switch status determination unit 32 which instructs the safety switch status determination unit 32 to make a determination of the status of the safety switches 30, as described in more detail below. The processor 40 may output the control signal to the safety switch status determination unit 32 after a first period of time, wherein the first period of time may be defined by a user (such as an owner or operator) or may be predefined. The first period of time may be long enough for the irrigation system 10 to settle—that is, for the towers 12 to come to a resting state and/or for the fluid to drain from the irrigation system 10. Additionally, or alternatively, the processor 40 may output the control signal to the safety switch status determination unit 32 on a periodic basis, such as once per minute, during the first period of time. In some embodiments, the processor 40 may also output an electronic relay signal to the relay 49 to switch the common contact from the normally closed (NC) contact to the normally open (NO) contact to allow for proper operation of the safety switch status determination unit 32.

The safety switch status determination unit 32 receives the control signal from the processor 40 and determines the status of the safety switch circuit 34 and, hence, whether any safety switch 30 is open. The safety switch status determination unit 32 utilizes low voltage electronic signals to determine, in near real time, if any safety switches 30 are open and, if so, which safety switch 30 is open. The safety switch status determination unit 32 then outputs an electronic safety switch status signal whose electrical characteristic level (voltage or current) or data varies according to the safety switch 30 status. For example, the safety switch status determination unit 32 may output the safety switch status signal having a first electrical characteristic level or data value if all of the safety switches 30 are closed. The safety switch status determination unit 32 may output the safety switch status signal having multiple electrical characteristic levels or data values when one of the safety switches 30 is open, wherein the electrical characteristic level or data value indicates the identification of, position of, location of, or distance to the tower 12 with the open safety switch 30. Specific operation of the safety switch status determination unit 32 is described in more detail below.

The processor 40 receives the safety switch status signal and takes action according to the status of the safety switches 30. If the safety switch status signal indicates that one of the safety switches 30 is open, then the processor 40 may determine the identification of, position of, location of, or distance to the tower 12 with the open safety switch 30 directly from the safety switch status signal. Or, the processor 40 utilizes the contents of the safety switch status signal as an input to a mathematical equation or as a key or index to a lookup table that determines the identification of, position of, location of, or distance to the tower 12 with the open safety switch 30. The processor 40 then transmits externally, and/or displays locally, a message indicating the identification of, position of, location of, or distance to the tower 12 with the open safety switch 30.

If the safety switch status signal indicates that all of the safety switches 30 are closed, then the processor 40 may transmit externally, and/or display locally, a message indicating that the irrigation system 10 had a shutdown, but is no longer in an unsafe condition and can now be restarted. Additionally, or alternatively, the processor 40 may automatically restart the irrigation system 10 by closing a switch, a relay, and/or a contactor that reconnects electric power to the fluid pumps and electric motors 26. The conduit 20 and the fluid delivery system may refill with fluid. The processor 40 may also transmit externally, or display locally, a message indicating that the irrigation system 10 had a shutdown and has been restarted.

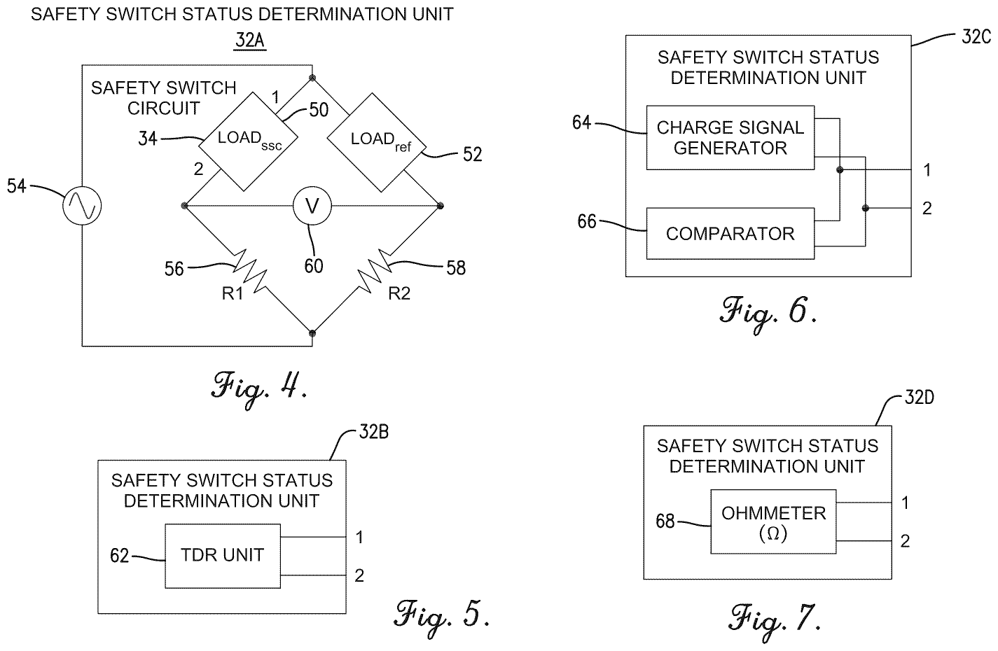

Referring to FIGS. 4-6, the safety switch status determination unit 32 will be discussed in more detail. The safety switch status determination unit 32 generally includes a first port 1 and a second port 2 which electrically connect to the safety switch circuit 34 and through which electronic signals are output in order to determine the status of the safety switches 30. The specific components and operation of the safety switch status determination unit 32 vary according to the embodiments shown in the figures. Referring to FIG. 4, a first embodiment of the safety switch status determination unit 32A broadly comprises a safety switch circuit load 50, a reference load 52, a voltage source 54, a first resistor 56, a second resistor 58, and a voltmeter 60. Typically, the safety switch status determination unit 32A is utilized in the configuration of the central controller 14 and the safety switch circuit 34 shown in FIG. 2. More details about the safety switch status determination unit 32A are disclosed in U.S. patent application Ser. No. ______, entitled “MECHANIZED IRRIGATION MACHINE THAT USES ELECTRICAL CHARACTERISTICS TO FIND AN OPEN SWITCH OR WIRE”, filed date, which is hereby incorporated by reference, in its entirety, into the current patent application, except where inconsistent with the teachings of the current patent application. The safety switch circuit load 50 is a virtual electrical component, including capacitors, inductors, resistors, or combinations thereof, that models the structure and behavior of the safety switch circuit 34. The safety switch circuit load 50 is electrically connected to the first port 1 and the second port 2. The reference load 52 is an actual electrical component, including capacitors, inductors, resistors, or combinations thereof, that matches the component used in the safety switch circuit load 50. For example, if a capacitor is used in the safety switch circuit load 50 to model the safety switch circuit 34, then a capacitor is used as the reference load 52. The voltage source 54 is a varying voltage source, such as an alternating current (AC) voltage source formed from known electric power supplies which output sine wave voltage with a selectively specified frequency and amplitude or a direct current (DC) square wave voltage source with a selectively specified frequency and amplitude. The first resistor 56 and the second resistor 58 typically have the same selectively specified resistance value. The safety switch circuit load 50, the reference load 52, the first resistor 56, and the second resistor 58 are connected to one another to form a symmetrical bridge circuit. The voltmeter 60, or voltage sensing circuitry, measures the voltage from the connection between the safety switch circuit load 50 and the first resistor 56 to the connection between the reference load 52 and the second resistor 58.

To determine the status of the safety switches 30, the safety switch status determination unit 32A applies a voltage from the voltage source 54 to the safety switch circuit 34, and the voltmeter 60 measures a differential voltage at the center of the bridge circuit (between the loads 50, 52 and the resistors 56, 58). In a first instance, the safety switch status determination unit 32A outputs the safety switch status signal, which has an electrical characteristic level or data value that varies according to the measured differential voltage. If the measured differential voltage is approximately to the voltage from the voltage source 54, then all of the safety switches 30 are closed. If the measured differential voltage is non-zero, then the level of the measured differential voltage varies according to an identification of, or a distance to, the tower 12 with the open safety switch 30. In a second instance, a processing unit (the processor 40 and/or a processor within the safety switch status determination unit 32A) adjusts the electrical characteristic (capacitance, inductance, and/or resistance) of the reference load 52 until the differential voltage measured by the voltmeter 60 is approximately zero Volts. The safety switch status determination unit 32A outputs the safety switch status signal, which has an electrical characteristic level or data value that varies according to the amount by which the electrical characteristic (capacitance, inductance, and/or resistance) was adjusted. If the amount of adjustment is approximately zero, then all of the safety switches 30 are closed. Otherwise, the amount of adjustment varies according to an identification of, or a distance to, the tower 12 with the open safety switch 30.

Referring to FIG. 5, a second embodiment of the safety switch status determination unit 32B broadly comprises a time domain reflectometry (TDR) unit 62. The safety switch status determination unit 32B is utilized in the configuration of the central controller 14 and the safety switch circuit 34 shown in FIGS. 2 and 3. More details about the safety switch status determination unit 32B are disclosed in U.S. patent application Ser. No. 18/410,514, entitled “MECHANIZED IRRIGATION MACHINE THAT USES TIME DOMAIN REFLECTIVITY TO FIND AN OPEN SWITCH OR WIRE”, filed Jan. 11, 2024, which is hereby incorporated by reference, in its entirety, into the current patent application, except where inconsistent with the teachings of the current patent application. The TDR unit 62 includes a first port electrically connected to the first port 1 of the safety switch status determination unit 32B and a second port electrically connected to the second port 2 of the safety switch status determination unit 32B. The TDR unit 62 generally outputs an electronic TDR signal on an electrically conductive path and determines characteristics of the path according to, or based on, a reflection of the TDR signal. Specifically, the TDR unit 62 outputs the TDR signal to the safety circuit 34 and waits for the reflection of the TDR signal. According to a time period between the outputting of the TDR signal and the reception of its reflections, the TDR unit 62 may determine the distance, or a representation of the distance, from the TDR unit 62 to the open safety switch 30. The time delay between the transmission of the TDR signal and the reception of its reflections may also indicate whether all safety switches 30 are closed. The safety switch status determination unit 32B outputs the safety switch status signal, which has an electrical characteristic level or data value that varies according to the time delay of the reflection(s) of the TDR signal.

Referring to FIG. 6, a third embodiment of the safety switch status determination unit 32C broadly comprises a charge signal generator 64 and a comparator 66. The safety switch status determination unit 32C is utilized in the configuration of the central controller 14 and the safety switch circuit 34 shown in FIGS. 2 and 3. More details about the safety switch status determination unit 32C are disclosed in U.S. patent application Ser. No. 18/410,514, entitled “MECHANIZED IRRIGATION MACHINE THAT USES TIME DOMAIN REFLECTIVITY TO FIND AN OPEN SWITCH OR WIRE”, filed Jan. 11, 2024, which is hereby incorporated by reference, in its entirety, into the current patent application, except where inconsistent with the teachings of the current patent application. The charge signal generator 64 includes a first port electrically connected to the first port 1 of the safety switch status determination unit 32B and a second port electrically connected to the second port 2 of the safety switch status determination unit 32B. For the safety switch status determination unit 32C, the first port 1 is electrically connected to the switch cable 44 and the second port 2 is electrically connected to the return cable 46. The charge signal generator 64 outputs an electronic charge signal on each of the first and second ports. The charge signal is typically a step increase in voltage from zero (0) Volts to a selectively defined charge voltage (V_{f}). The comparator 66 compares the rising voltage on either the switch cable 44 or the return cable 46 to the charge voltage V_{f}. The comparator 66 outputs an electronic comparator signal which has a first voltage level or binary value when the voltage on either cable 44, 46 is less than the charge voltage and a second voltage level or binary value when the voltage on either cable 44, 46 is equal to or greater than the charge voltage. The processor 40, or other processor, may measure a rise time period from when the charge signal was applied to when the comparator signal switched values (as the voltage on either cable 44, 46 rose to the charge voltage V_{f}). According to the value of the rise time period, the processor 40 determines if any safety switches 30 are open and if so, which one.

Referring to FIG. 7, a fourth embodiment of the safety switch status determination unit 32D broadly comprises an ohmmeter 68 configured or capable to measure electrical resistance in ohms. The ohmmeter 68 may include components such as voltage supplies, current supplies, voltmeters, current meters, ADCs, processors, and the like. The ohmmeter 68 includes a first port and a second port. The ohmmeter 68 outputs a current and measures a voltage or outputs a current and measures a voltage, wherein the resistance is determined as the voltage divided by the current. The ohmmeter 68 measures the resistance of the safety switch circuit 34. The safety switch status determination unit 32D outputs the safety switch status signal, which has an electrical characteristic level or data value that varies according to the measured resistance of the safety switch circuit 34. The processor 40 receives the safety switch status signal and determines the status of the safety switches 30 according to the measured resistance. If the measured resistance is greater than a threshold, such as 1 megaohm (MΩ), then it is likely that one of the safety switches 30 is open. If the measured resistance is less than the threshold, such as a value less than 100Ω, then it is likely that all of the safety switches 30 are closed. The processor 40 then takes appropriate action based on the status of the safety switches 30.

Referring again to FIGS. 2 and 3, in certain embodiments, the safety signal source 42 may act as the safety switch status determination unit 32 and perform at least a portion of the functions of the safety switch status determination unit 32. Normally, the safety signal source 42 checks for electrical continuity on the safety switch circuit 34 during powered operation of the irrigation system 10. Once one of the safety switches 30 opens, the safety signal source 42 detects that there is no longer electrical continuity on the safety switch circuit 34, and the safety signal source 42 alerts the processor 40 of the central controller 14, which shuts down the operation of the irrigation system 10 by removing electric power from the electrical components (drive motors, pumps, etc.). In some situations, after the first period of time has passed, the processor 40 may instruct the safety signal source 42 to recheck for electrical continuity on the safety switch circuit 34. Typically, the safety signal source 42 includes a voltage supply that applies a first value of voltage to one of either the switch cable 44 or the return cable 46 and determines if a second value of voltage is present on the other of either the switch cable 44 or the return cable 46. There is likely to be a voltage drop from all of the safety switches 30 and the lengths of the cables 44, 46. Thus, the second value of voltage is less than the first value of voltage. The voltage may have a first value of approximately 120 VAC. If the second value of voltage is present, then there is electrical continuity on the safety switch circuit 34 and the safety signal source 42 outputs the safety signal, which indicates that electrical continuity is present, i.e., all safety switches 30 closed. The processor 40 receives the safety signal and may transmit externally, and/or display locally, a message indicating that the irrigation system 10 had a shutdown, but is no longer in an unsafe condition and can now be restarted. Additionally, or alternatively, the processor 40 may automatically restart the irrigation system 10 by closing a switch, a relay, or a contactor that reconnects electric power to the fluid pumps and electric motors 26. The conduit 20 and the fluid delivery system may refill with fluid. The processor 40 may also transmit externally, and/or display locally, a message indicating that the irrigation system 10 had a shutdown and has been restarted.

If the voltage is not present, then it is likely that at least one safety switch 30 is open and the safety signal source 42 outputs the safety signal indicating that one of the safety switches 30 is open. The processor 40 receives the safety signal and may determine the identification of, position of, location of, or distance to the tower 12 with the open safety switch 30 directly from the safety switch status signal. The processor 40 then transmits externally, and/or displays locally, a message indicating the identification of, position of, location of, or distance to the tower 12 with the open safety switch 30.

In other embodiments, the safety signal source 42 may recheck for electrical continuity on the safety switch circuit 34 by applying a lower first value of voltage to one of either the switch cable 44 or the return cable 46. The voltage may have a value of less than approximately 50 VAC or 50 VDC. The lower level of voltage applied to the cables 44, 46 of the safety switch circuit 34 may be less harmful to a technician who is working on the irrigation system 10 to determine the cause of the original shutdown of the irrigation system 10 and who may be touching one of the cables 44, 46. Other than applying a lower first value of voltage to the safety switch circuit 34, the safety signal source 42 operates in the same, or similar, manner as described above.

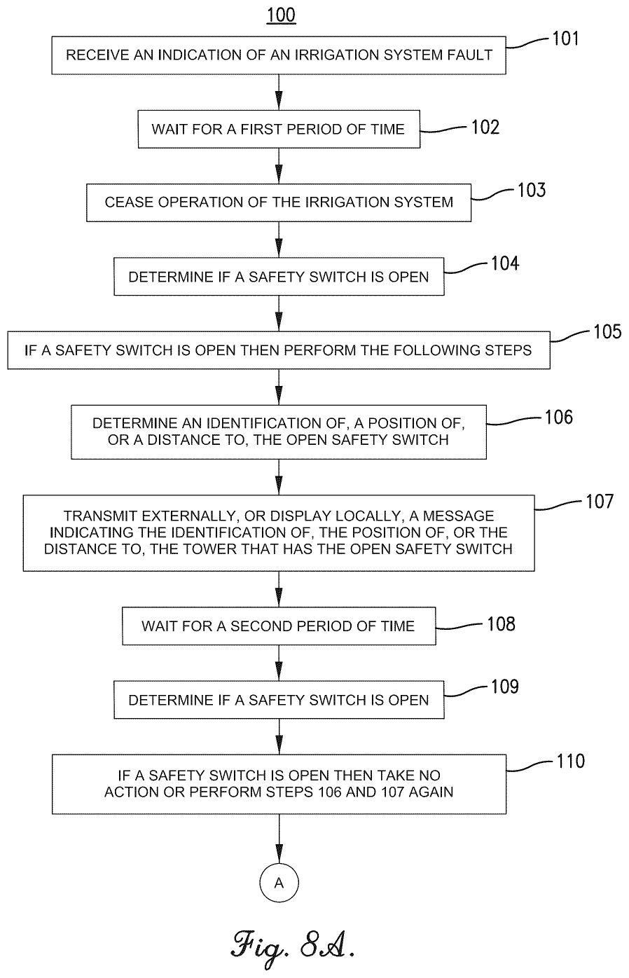

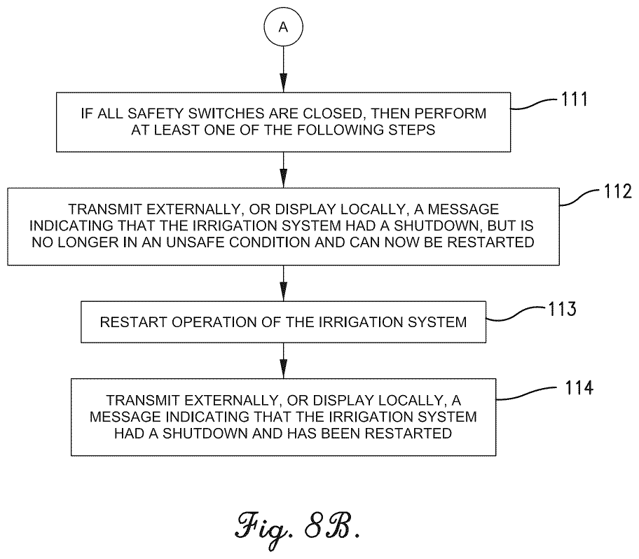

FIGS. 8A and 8B depict a listing of at least a portion of the steps of an exemplary method 100 for notifying a user that an irrigation system 10 fault has been cleared. Variations to the steps may be performed. The steps may be performed in the order shown in FIGS. 8A and 8B, or they may be performed in a different order. Furthermore, some steps may be performed concurrently as opposed to sequentially. In addition, some steps may be optional or may not be performed.

Referring to steps 101, 102, and 103, an indication of an irrigation system 10 fault is received. A processor 40 receives an electronic safety signal from a safety signal source 42. If the safety signal indicates that the there is electrical continuity on a safety switch circuit 34, then the processor 40 takes no specific action. If the safety signal indicates that a lack of electrical continuity on the safety switch circuit 34 (which is considered a fault), then the processor 40 may wait for a first period of time, such as a few seconds or less, in case one of the safety switches 30 momentarily opened and then closed again. After the first period of time passes, the processor 40 may halt operation of the irrigation system 10 by opening a switch, a relay, or a contactor that supplies electric power to the motors 26 and to the fluid delivery system. The processor 40 also controls the settings of the pumps, valves, and other components of the fluid delivery system to drain the fluid from the fluid delivery system including a conduit 20. Draining of the fluid delivery system may take approximately 15-20 minutes.

Referring to step 104, it is determined if a safety switch 30 is open. The processor 40 outputs an electronic control signal, including a voltage or current level or data, to the safety switch status determination unit 32 which instructs the safety switch status determination unit 32 to make a determination of the status of the safety switches 30, as described in more detail below.

The safety switch status determination unit 32 receives the control signal from the processor 40 and determines the status of the safety switch circuit 34 and, hence, whether any safety switch 30 is open. The safety switch status determination unit 32 utilizes low voltage electronic signals to determine, in near real time, if any safety switches 30 are open and, if so, which safety switch 30 is open. The safety switch status determination unit 32 then outputs an electronic safety switch status signal whose electrical characteristic level (voltage or current) or data varies according to the safety switch 30 status. For example, the safety switch status determination unit 32 may output the safety switch status signal having a first electrical characteristic level or data value if all of the safety switches 30 are closed. The safety switch status determination unit 32 may output the safety switch status signal having multiple electrical characteristic levels or data values when one of the safety switches 30 is open, wherein the electrical characteristic level or data value indicates the identification of, position of, location of, or distance to the tower 12 with the open safety switch 30.

Referring to steps 105, 106, and 107, if the safety switch status signal indicates that one of the safety switches 30 is open, then the processor 40 may determine the identification of, position of, location of, or distance to the tower 12 with the open safety switch 30 directly from the safety switch status signal. Or, the processor 40 utilizes the contents of the safety switch status signal as an input to a mathematical equation or as a key or index to a lookup table that determines the identification of, position of, location of, or distance to the tower 12 with the open safety switch 30. The processor 40 transmits externally, and/or displays locally, a message indicating the identification of, position of, location of, or distance to the tower 12 with the open safety switch 30.

Referring to steps 108, 109, and 110, the processor 40 waits for a second period of time, which may be defined by a user (such as an owner or operator) or may be predefined. The processor 40 again instructs the safety switch status determination unit 32 to make a determination of the status of the safety switches 30. If at least one of the safety switches 30 is still open, then the processor 40 may take no additional action, or the processor 40 may again determine the identification of, position of, location of, or distance to the tower 12 with the open safety switch 30.

Referring to steps 111, 112, 113, and 114, when coming from step 104 or step 109, if the safety switch status signal indicates that all of the safety switches 30 are closed, then the processor 40 may transmit externally, and/or display locally, a message indicating that the irrigation system 10 had a shutdown, but is no longer in an unsafe condition and can now be restarted. Additionally, or alternatively, the processor 40 may automatically restart the irrigation system 10 by closing a switch, a relay, or a contactor that reconnects electric power to the fluid pumps and electric motors 26. The conduit 20 and the fluid delivery system may refill with fluid. The processor 40 may also transmit externally, and/or display locally, a message indicating that the irrigation system 10 had a shutdown and has been restarted.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as communication elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. An irrigation system comprising:
a plurality of towers, at least a portion of the towers including a successive one of a plurality of safety switches, each safety switch being either closed or open, the safety switch of each tower electrically connected to at least one safety switch of another tower;
a safety switch status determination unit configured to:
determine a status of the safety switches, and
output an electronic safety switch status signal whose level or data value varies according to whether all of the safety switches are closed or one of the safety switches is open; and
a controller configured to:
receive an indication of an irrigation system fault,
cease operation of the irrigation system,
instruct the safety switch status determination unit to determine the status of the safety switches,
receive the safety switch status signal,
perform at least one of the following steps if the safety switch status signal indicates that all of the safety switches are closed:
transmit externally, display locally, or both, a message indicating that the irrigation system had a shutdown, but is no longer in an unsafe condition and can now be restarted,
restart operation of the irrigation system, and
transmit externally, or display locally, or both, a message or indication that the irrigation system had a shutdown and has been restarted.

2. The irrigation system of claim 1, wherein the controller is further configured to perform the following steps if the safety switch status signal indicates that one of the safety switches is open:
determine an identification of, a position of, or a distance to, the open safety switch, and
transmit externally, display locally, or both, a message indicating the identification of, the position of, or the distance to, the tower that has the open safety switch.

3. The irrigation system of claim 1, wherein the safety switch status determination unit includes:
a safety switch circuit load, a reference load, a first resistor, and a second resistor electrically connected to one another to form a bridge circuit,
a voltage source configured to output a varying voltage to the bridge circuit, and
a voltmeter configured to measure a differential voltage from a first point between the safety switch circuit load and the first resistor to a second point between the reference load and the second resistor,
wherein the level or data value of the safety switch status signal varies according to a level of the differential voltage.

4. The irrigation system of claim 3, wherein the reference load includes an adjustable electrical characteristic and the level or data value of the safety switch status signal varies according to an amount by which the electrical characteristic is adjusted to make the differential voltage equal approximately zero Volts.

5. The irrigation system of claim 1, wherein the safety switch status determination unit includes a time domain reflectometry (TDR) unit electrically connected to a safety switch circuit including the switches, a switch cable including a plurality of sections that electrically connect the controller to a first safety switch and the safety switches to one another, and a return cable electrically connecting the safety switch at one of a plurality of outer towers to the controller, the TDR unit to output an electronic TDR signal to the safety switch circuit and receive a reflection of the TDR signal and the level or data value of the safety switch status signal varies according to a period of time between the outputting of the TDR signal and the reception of its reflection.

6. The irrigation system of claim 1, wherein the safety switch status determination unit includes:
a charge signal generator electrically connected to a safety switch circuit including the switches, a switch cable including a plurality of sections that electrically connect the controller to a first safety switch and the safety switches to one another, and a return cable electrically connecting the safety switch at one of a plurality of outer towers to the controller, the charge signal generator configured to output an electronic charge signal to the safety switch circuit, and
a comparator electrically connected to the safety switch circuit and configured to output an electronic comparator signal whose level or data value changes when a voltage on the safety switch circuit increases to a particular value.

7. The irrigation system of claim 6, wherein the controller is further configured to receive the comparator signal and determine whether all of the safety switches are closed or one of the safety switches is open according to a value of a period of time between the charge signal generator outputting the charge signal and the changing the level or data value of the comparator signal.

8. The irrigation system of claim 1, wherein the safety switch status determination unit includes an ohmmeter to
measure an electrical resistance of a safety switch circuit including the switches, a switch cable including a plurality of sections that electrically connect the controller to a first safety switch and the safety switches to one another, and a return cable electrically connecting the safety switch at one of a plurality of outer towers to the controller, and
output the safety switch status signal whose level or data value varies according to the measured resistance.

9. The irrigation system of claim 1, wherein the safety switch status determination unit is configured to
apply a voltage of a first value to one of
a switch cable including a plurality of sections that electrically connect the controller to a first safety switch and the safety switches to one another, or
a return cable electrically connecting the safety switch at one of a plurality of outer towers to the controller,
detect whether a voltage of a second value is present on the other of the switch cable or the return cable, and
output the safety switch status signal whose level or data value varies according to whether the voltage is present on the other of the switch cable or the return cable.

10. An irrigation system comprising:
a plurality of towers, at least a portion of the towers including a successive one of a plurality of safety switches, each safety switch being either closed or open, the safety switch of each tower electrically connected to at least one safety switch of another tower;
a safety switch status determination unit electrically connected to a safety switch circuit including the switches, a switch cable having a plurality of sections that electrically connect the safety switches to one another, and a return cable electrically connected the safety switch at one of a plurality of outer towers, the safety switch status determination unit configured to:
determine a status of the safety switches, and
output an electronic safety switch status signal whose level or data value varies according to whether all of the safety switches are closed or one of the safety switches is open; and
a controller configured to:
receive an indication of an irrigation system fault,
cease operation of the irrigation system,
instruct the safety switch status determination unit to determine the status of the safety switches,
receive the safety switch status signal,
perform at least one of the following steps if the safety switch status signal indicates that all of the safety switches are closed:
transmit externally, display locally, or both, a message indicating that the irrigation system had a shutdown, but is no longer in an unsafe condition and can now be restarted,
restart operation of the irrigation system,
transmit externally, or display locally, or both, a message or indication that the irrigation system had a shutdown and has been restarted, and
perform the following steps if the safety switch status signal indicates that one of the safety switches is open:
determine an identification of, a position of, or a distance to, the open safety switch, and
transmit externally, display locally, or both, a message indicating the identification of, the position of, or the distance to, the tower that has the open safety switch.

11. The irrigation system of claim 10, wherein the safety switch status determination unit includes:
a safety switch circuit load, a reference load, a first resistor, and a second resistor electrically connected to one another to form a bridge circuit,
a voltage source configured to output a varying voltage to the bridge circuit, and
a voltmeter configured to measure a differential voltage from a first point between the safety switch circuit load and the first resistor to a second point between the reference load and the second resistor,
wherein either the level or data value of the safety switch status signal varies according to a level of the differential voltage, or
the reference load includes an adjustable electrical characteristic and the level or data value of the safety switch status signal varies according to an amount by which the electrical characteristic is adjusted to make the differential voltage equal approximately zero Volts.

12. The irrigation system of claim 10, wherein the safety switch status determination unit includes:
a time domain reflectometry (TDR) unit electrically connected to the safety switch circuit and the TDR unit is configured to output an electronic TDR signal to the safety switch circuit and receive a reflection of the TDR signal and the level or data value of the safety switch status signal varies according to a period of time between the outputting of the TDR signal and the reception of its reflection.

13. The irrigation system of claim 10, wherein the safety switch status determination unit includes:
a charge signal generator electrically connected to a safety switch circuit including the switches, a switch cable including a plurality of sections that electrically connect the controller to a first safety switch and the safety switches to one another, and a return cable electrically connecting the safety switch at a last tower to the controller, the charge signal generator configured to output an electronic charge signal to the safety switch circuit, and
a comparator electrically connected to the safety switch circuit and configured to output an electronic comparator signal whose level or data value changes when a voltage on the safety switch circuit increases to a particular value.

14. The irrigation system of claim 13, wherein the controller is further configured to receive the comparator signal and determine whether all of the safety switches are closed or one of the safety switches is open according to a value of a period of time between the charge signal generator outputting the charge signal and the changing the level or data value of the comparator signal.

15. A method for notifying a user that an irrigation system fault has been cleared, the irrigation system including a plurality of towers, with at least a portion of the towers including a successive one of a plurality of safety switches, each safety switch being either closed or open, the method comprising:
receiving an indication of an irrigation system fault;
ceasing operation of the irrigation system;
determining if a safety switch is open or if all safety switches are closed;
performing at least one of the following steps if all safety switches are closed;
transmitting externally, displaying locally, or both, a message indicating that the irrigation system had a shutdown, but is no longer in an unsafe condition and can now be restarted;
restarting operation of the irrigation system; and
transmitting externally, or display locally, or both, a message or indication that the irrigation system had a shutdown and has been restarted.

16. The method of claim 15, further comprising:
performing the following steps if at least one safety switch is open;
determining an identification of, a position of, or a distance to, the open safety switch; and
transmitting externally, or displaying locally, or both, a message indicating the identification of, the position of, or the distance to, the tower that has the open safety switch.

17. The method of claim 15, wherein determining if a safety switch is open or if all safety switches are closed further includes:
applying a varying voltage to a bridge circuit including a safety switch circuit load, a reference load, a first resistor, and a second resistor;
measuring a differential voltage from a first point between the safety switch circuit load and the first resistor to a second point between the reference load and the second resistor; and
determining a status of the safety switches according to a level of the differential voltage.

18. The method of claim 15, wherein determining if a safety switch is open or if all safety switches are closed further includes:
applying a varying voltage to a bridge circuit including a safety switch circuit load, a reference load, a first resistor, and a second resistor;
measuring a differential voltage from a first point between the safety switch circuit load and the first resistor to a second point between the reference load and the second resistor;
adjusting an electrical characteristic of the reference load so that the differential voltage equals approximately zero Volts; and
determining a status of the safety switches according to an amount by which the electrical characteristic is adjusted.

19. The method of claim 15, wherein determining if a safety switch is open or if all safety switches are closed further includes:
applying an electronic signal to a safety switch circuit including the switches, a switch cable including a plurality of sections that electrically connect the controller to a first safety switch and the safety switches to one another, and a return cable electrically connecting the safety switch at one of a plurality of outer towers to the controller;
receiving a reflection of the electronic signal; and
determining a status of the safety switches according to a period of time between applying the electronic signal and receiving the reflection.

20. The method of claim 15, wherein determining if a safety switch is open or if all safety switches are closed further includes:
applying an electronic charge signal to a safety switch circuit including the switches, a switch cable including a plurality of sections that electrically connect the controller to a first safety switch and the safety switches to one another, and a return cable electrically connecting the safety switch at one of a plurality of outer towers to the controller;
outputting an electronic comparator signal whose level or data value changes when a voltage on the safety switch circuit increases to a particular value; and
determining a status of the safety switches according to a period of time between applying the charge signal and the change of the level or value of the comparator signal.
